(19) United States
(12) Patent Application Publication
(10) Pub. No.: US 2024/0344984 A1
(43) Pub. Date: Oct. 17, 2024

(54) MULTI-DIMENSIONAL WIDEFIELD INFRARED-ENCODING SPONTANEOUS EMISSION (“MD-WISE”) MICROSCOPY

(71) Applicant: THE REGENTS OF THE UNIVERSITY OF CALIFORNIA, Oakland, CA (US)

(72) Inventors: Chang YAN, La Jolla, CA (US); Wei XIONG, La Jolla, CA (US)

(21) Appl. No.: 18/628,398

(22) Filed: Apr. 5, 2024

Related U.S. Application Data
(60) Provisional application No. 63/458,060, filed on Apr. 7, 2023.

(51) Int. Cl. G01N 21/64; B82Y 15/00; B82Y 20/00; G01N 21/63

(52) U.S. Cl. CPC G01N 21/6428; G01N 21/6456; B82Y 15/00; B82Y 20/00; G01N 2021/634; G01N 2021/6439

(57) ABSTRACT

A multiplexed widefield imaging method employs spatially focusing femtosecond infrared (IR) pulses and visible pulses delayed by a controlled temporal delay onto a sample stained with one or more chromophore to excite spontaneous emitted photoluminescence (PL) signals from the chromophores. The resulting PL signals are detected to generate PL images in which intensities of the PL signals are a function of optical frequencies of the IR and visible pulses and the temporal delay.

### RELATED APPLICATIONS

This application claims the benefit of the priority of U.S. Provisional Application No. 63/458,060, filed Apr. 7, 2023, which is incorporated herein by reference in its entirety.

### GOVERNMENT RIGHTS

This invention was made with government support under Grant No. 1R35GM138092-01 awarded by the National Institutes of Health. The government has certain rights in the invention.

### FIELD OF THE INVENTION

The present invention relates to a multiplexed widefield imaging method that uses femtosecond mid-infrared and visible excitation pulses to distinguish chromophores.

### BACKGROUND

Photoluminescence (PL) imaging techniques based on the spontaneous emission have achieved single-molecule level sensitivity and sub-diffraction spatial resolution, making them vital tools for fields including bioimaging and material characterization. An intrinsic limitation in the technique has been the number of color channels available for multiplexed imaging, since PL chromophores in the visible and adjacent spectral regions often have broad emission spectra that overlap each other. To address this limitation, techniques involving other molecular degrees of freedoms have been developed for multiplexed imaging and chemical imaging. Among them, Raman vibrational microscopy and infrared (IR) photothermal microscopy have been highly successful. Nonetheless, the detection limits of these methods are generally less sensitive than PL-based techniques.

Recently, a few techniques have emerged to encode vibrational information into fluorescence signals, enabling highly sensitive far-field detection and multiplexed imaging of specific fluorophores. One method is based on encoding fluorescence signal by the change of the temperature around fluorophores following vibrational relaxation, as demonstrated by the fluorescence-detected mid-infrared photothermal microscopy. While photothermal methods can be useful, they are intrinsically based on the optical response of a fluorophore to changes in the matrix environment, making their sensitivity dependent on properties of the matrix. Nonlinear optical methods which resonantly excite multiple transitions of a molecule benefit from the inherent properties of the chromophore. Using the stimulated Raman transition to excite vibrational modes and encode a fluorophore's emission intensity, the stimulated Raman excited fluorescence microscopy has been demonstrated as a powerful multiplexed PL imaging method with single-molecule level sensitivity at ambient conditions. However, nonlinear optical microscopies typically operate by focusing optical beams tightly onto the sample of interest, since the cross-sections of higher order nonlinear interactions are orders of magnitudes lower than first-order absorption cross-sections. This imaging condition has limited the possibility of applying nonlinear optical processes in widefield multiplexed PL imaging.

Multiplexed widefield PL microscopy possesses certain intrinsic advantages relative to confocal microscopy such as lower photodamage and faster imaging speed. Widefield microscopies have been successful for tracking fast cellular dynamics and fast energy dissipation processes in materials. Multiplexed PL images are encoded with a large amount of information that needs to be collected over a set of different imaging conditions such as excitation frequencies. As the multiplexed data collection process can be time-consuming, the widefield mode may become an important module for fast multiplexed PL imaging methods.

A general strategy of nonlinear optical multiplexed PL imaging is to excite other degrees of freedom in addition to the linear electronic transitions to modulate the electronic absorption or the subsequent PL emission process, as demonstrated by prior works of nonlinear spectroscopy. The nature of a widefield nonlinear optical microscope requires these additional optical processes to possess large cross-sections, thus making them compatible with the condition of lower photon flux. Using ultrafast mid-IR pulses, two types of processes are possible during which the IR excitation modulate the associated electronic absorption or emission processes (referred to as IR-Visible nonlinear interactions). The first type is exciting molecular vibrations through the linear absorption of a mid-IR photon that further modulate the electronic absorptions. Linear mid-IR absorption typically has a much larger cross-section than nonlinear vibrational excitation such as Raman-based processes. The infrared-visible double-resonance process, during which a dye molecule sequentially absorbs a mid-IR photon and then a visible photon, can encode PL signals in the widefield configuration. The second IR-visible nonlinear interaction is based on the strong electric field of femtosecond mid-IR pulses, which can reach the order of megavolts per centimeter (MV/cm) due to the high peak power and the relatively long wavelength. Such electric fields can ionize excitons in semiconductor materials, affecting the PL intensity of quantum dot (QD) emitters.

### SUMMARY

According to embodiments of the inventive approach, the action of a mid-IR pulse is able to distinguish photoluminescence (PL) chromophores, including molecules and quantum dots (QDs), in multiplexed widefield imaging via the distinct responses of the chromophores either to the IR frequency or the temporal delay between ultrafast pulses. The inventive scheme enables expansion of visible spectral colors, a one-dimensional variable, into multiple dimensions. For example, traditional fluorescence microscopy can usually only operate with four different colors—blue, green, red, and far red. Using the inventive approach, these colors can be expanded into multi-dimensional variables, including various colors in mid infrared, and various time delays, facilitating simultaneous tracking of multiple (potentially tens or even hundreds) chromophores within the same field of view in wide-field imaging. This drastically increases the amount of information that can be quickly extracted in photoluminescence imaging, potentially revolutionizing bioimaging and materials characterization.

The inventive approach is referred to as “Multi-Dimensional Widefield Infrared-encoding Spontaneous Emission” or “MD-WISE” microscopy. A pair of femtosecond IR and visible pulses delayed by a controlled interval, t, travel collinearly and are spatially focused onto the sample of interest by a reflective objective. The spontaneously emitted PL signals from the chromophores, following the ultrafast interactions of the two pulses, are collected by a refractive objective to form a widefield image on an image detector such as a charge-coupled device (CCD) or CMOS camera or other pixel array-type detector. The intensity of the PL image is a function of the optical frequencies of the IR and visible pulses, as well as the temporal delay t. Thus, by taking the intensity difference of the PL images acquired with or without the IR pulse, difference images reveal species of which the PL is encoded by the IR pulse, either through vibrational excitation or strong field interactions.

Because the mechanisms that encode PL are time-dependent, MD-WISE realizes a three-dimensional condition space formed by the three orthogonal variables: the IR frequency, the visible wavelength, and the ultrafast delay t. By choosing the appropriate condition in the space, many chromophores having nearly identical PL spectra or emitting in the same PL collection wavelength range thus can be distinguished in MD-WISE. By demonstrating the capacity of registering multi-dimensional information into widefield PL images, MD-WISE microscopy has the potential of further expanding the number of species and processes that can be simultaneously tracked in high-speed chemical and biological imaging applications.

In one aspect, a multiplexed widefield imaging method includes spatially focusing femtosecond IR pulses and visible pulses delayed by a controlled temporal delay onto a sample comprising at least one chromophore to excite spontaneous emitted PL signals from the at least one chromophore; and detecting at a detector the PL signals to generate PL images, wherein intensities of the PL signals within the PL images are a function of optical frequencies of the IR and visible pulses and the temporal delay. The method further includes chopping the IR pulse using an optical chopper; synchronizing a frame rate of the detector with the optical chopper; and determining an intensity difference of PL signals acquired with and without the IR pulse, wherein the intensity difference indicates a subset of PL signals that are encoded by the IR pulse. The subset of PL signals that are encoded by the IR pulse may be generated by molecular excitation. The molecular excitation may be double resonance, wherein the IR pulse promotes molecules within the one or more chromophore to an exited vibrational state and the visible pulse promotes the molecules to an electronic excited level. The at least one chromophore may be quantum dots (QDs) and the subset of PL signals that are encoded by the IR pulse comprise strong field ionization of excitons of QDs.

In some embodiments, detecting further includes collecting the PL signals using a refractive objective to form a widefield image at the detector. The detector may be an array of pixels configured acquire to a widefield image in a single frame.

The femtosecond pulses may be generated using a femtosecond laser having a repetition rate in the range from 1 to 1,000 kHz, wherein the femtosecond laser is used to pump one or more optical parametric amplifiers (OPA) to produce the IR and visible pulses. The sample may be cells co-stained with chromophores comprising quantum dots (QDs) and molecular dye having at least partially overlapping PL spectra, wherein the QDs and molecular dyes are distinguishable by tuning the temporal delay. In some embodiments, the at least one chromophore comprises multiple chromophores having at least partially overlapping PL spectra, wherein the multiple chromophores are distinguishable via different responses to a mid-infrared pulse. The different responses may be intramolecular anharmonic coupling between different vibrational modes or Fermi resonances.

In another aspect, a method for distinguishing chromophores in a sample may include spatially focusing femtosecond IR and visible pulses delayed by a controlled temporal delay onto the sample stained with chromophores to excite spontaneous emitted PL signals; and detecting at a detector the PL signals to generate a PL image, wherein intensities within the PL image are a function of optical frequencies of the IR and visible pulses and the temporal delay. The method may further include chopping the IR pulse using an optical chopper; synchronizing a frame rate of the detector with the optical chopper; and determining an intensity difference of PL signals acquired with and without the IR pulse, wherein the intensity difference indicates a subset of PL signals that are encoded by the IR pulse. The subset of PL signals that are encoded by the IR pulse may be generated by molecular excitation. The molecular excitation may be double resonance, wherein the IR pulse promotes molecules within the chromophores to an exited vibrational state and the visible pulse promotes the molecules to an electronic excited level. The chromophores may be quantum dots (QDs) and the subset of PL signals that are encoded by the IR pulse comprise strong field ionization of excitons of QDs.

In some embodiments, detecting further includes collecting the PL signals using a refractive objective to form a widefield image at the detector. The detector may be an array of pixels configured acquire to a widefield image in a single frame.

The femtosecond pulses may be generated using a femtosecond laser having a repetition rate in the range from 1 to 1,000 kHz, wherein the femtosecond laser is used to pump one or more optical parametric amplifiers (OPA) to produce the IR and visible pulses. The sample may be cells co-stained with chromophores comprising quantum dots (QDs) and molecular dye having at least partially overlapping PL spectra, wherein the QDs and molecular dyes are distinguishable by tuning the temporal delay. In some embodiments, the chromophores have at least partially overlapping PL spectra, wherein the chromophores are distinguishable via different responses to a mid-infrared pulse. The different responses may be intramolecular anharmonic coupling between different vibrational modes or Fermi resonances.

The inventive approach provides key improvements in that it operates multiplexing condition in a n-dimensional space (n>2), with a large number of chromophores can be used. This is in contrast with stimulated Raman excitation fluorescence microscopy and mid-infrared photothermal fluorescence microscopy, where the only tunable condition is the infrared frequency. Further, the multiplexing microscopy operates under widefield, a much faster imaging mode than confocal imaging mode. This is the first nonlinear optical multiplexing photoluminescence microscopy that operates in widefield mode.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIG. 1A is a schematic illustration of MD-WISE microscopy, positive delay of denotes that the IR pulse arrives earlier than the visible pulse; FIG. 1B diagrammatically illustrates that the intensity of PL signals generated following the visible excitation pulse can be encoded by the optical frequency of IR pulse or the delay t. By taking the difference images with or without IR pulse, various chromophores can be distinguished apart even if their emission spectra are nearly identical. FIG. 1C illustrates the change in a chromophore's PL induced by the IR pulse-either there is no change (solid underline), or increased PL (dashed underline) or decreased PL (double underline), is a function of independently tunable variables expressed as the three orthogonal axes: visible excitation wavelength λᵥᵢₛ (nm), IR frequency ω_{IR} (cm⁻¹), and ultrafast delay t (ps). By choosing a condition (▴) in the three-dimensional space, pairs of chromophores with nearly identical PL spectra can be distinguished from each other, such as pairs of QD versus R6G and FITC versus fluorescein. The two shaded planes are condition planes having the same delay, +1 or −10 ps, and the coordinates in the in the brackets are expressed as (λᵥᵢₛ, ω_{IR}).

FIGS. 2A-2E illustrate the IR-encoding mechanism according to the inventive scheme. FIG. 2A shows the DRIFTS results of silica microspheres and pure R6G dye. The colored shade areas mark the IR excitation frequencies covered in MD-WISE imaging experiments of silica absorption (grey). FIG. 2B illustrates the molecular structure of R6G, and scheme of double-resonance excitation process and the subsequent spontaneous emission of fluorescence. FIG. 2C plots ultrafast transient absorption (upper panel) spectra of R6G in IR-pump-Vis-probe experiments. The steady-state absorption (solid line) and emission spectra (dashed line) of R6G-stained silica beads are in the bottom panel. Shaded area #1 marks the excitation wavelength of the visible pulse, tuned to the excited-state absorption region in the pump-probe spectra. Shaded area #2 marks the collection window of the emission signal. FIG. 2D provides widefield images of a silica bead, including the image collected without IR excitation and several difference images collected with the 1600±30 cm⁻¹ IR pulse delayed at different times. The color bars represent the counts on the detector pixels. Scale bars are 1 micron. FIG. 2E plots the kinetic traces of the relative difference of emission intensity in the widefield images acquired with and without IR pulse, measured with five different center frequencies of the IR pulse.

FIGS. 3A-3E illustrates the results of IR-encoding mechanism 2: strong field ionization of excitons in QDs. FIG. 3A diagrammatically illustrates the process during which the electric field of mid-IR pulse quenches the PL emission of a QD following visible pulse excitation. FIG. 3B plots visible absorption spectrum of the QD-stained silica microspheres, and the visible excitation wavelength (green) in MD-WISE imaging. FIG. 3C plots the PL spectra of the QD-stained silica microspheres, showing the IR pulse (2100±30 cm⁻¹) reduces the emission intensity significantly and redshifts emission spectrum. The red area represents the collection window used for MD-WISE imaging. FIG. 3D plots the kinetic trace of the relative difference of emission intensity in the widefield image induced by the IR pulse (2100±30 cm⁻¹). FIG. 3E provides a widefield image of a silica bead without IR excitation and a difference image with the IR pulse delayed to −10 ps show that the PL signal is significantly quenched by the IR.

FIGS. 4A-4E illustrate the results of distinguishing molecular dyes by tuning the IR frequency. FIG. 4A shows molecular structures of fluorescein and FITC anions. FIG. 4B plots steady-state absorption (solid lines) and emission (dashed lines) spectra of FITC and fluorescein adsorbed on silica beads. The shaded area #1 marks (520±5 nm) the excitation wavelength of the visible pulse, and shaded area #2 (585±18 nm) marks the collection window of fluorescence signals in MD-WISE imaging. FIG. 4C shows the ultrafast kinetic traces of the relative difference of emission intensity in the widefield images induced by the IR pulse, measured using silica beads stained with FITC and fluorescein at 1600 cm-1 and 2040 cm⁻¹. FIG. 4D provides DRIFTS spectra of FITC and fluorescein. Tuning the IR center frequency to 1600 cm-1 or 2040 cm⁻¹ excites the common vibrational modes of the xanthene ring or the isothiocyanate group unique to FITC, respectively. FIG. 4E illustrates responses of stained beads at different conditions where the left column is the fluorescence image of a single 3-micron bead without IR pulse. The middle and right panels are the difference images at 1=+1 ps acquired at 1600 cm-1±30 cm-1 and 2040±30 cm⁻¹, respectively. All scale bars are 1 micron.

FIGS. 5A-5F illustrate the results of distinguishing QDs from molecular dyes by tuning the ultrafast delay between pulses. In FIG. 5A, the top row shows three IR-off images of 3-micron silica beads stained with R6G co-mixed with 2-micron silica beads stained with QDs. In the bottom row, the difference images acquired using an IR frequency centered at 1600 cm⁻¹ with delay set to −10 ps show that the QD beads can be distinguished from the R6G beads. The color bars represent the counts on detector CCD pixels. Scale bars are 2 microns. FIGS. 5B-5D are white light bright field image of fixed cells, and red-channel PL images of PI-stained, and QD-stained fixed cells, respectively. FIG. 5E shows a widefield PL image of a PI-stained cell without using the IR pulse (left) and the difference PL image at −10 ps (right) acquired using MD-WISE microscopy. FIG. 5F provides a widefield PL image of a QD-stained cell without using the IR pulse (left) and the difference PL image at −10 ps (right) acquired using MD-WISE microscopy. The images in FIGS. 5E and 5F were acquired using IR frequency centered at 2100 cm⁻¹, visible excitation at 550±5 nm and PL collection wavelength range of 585±18 nm.

FIGS. 6A-6F illustrate the results of the inventive approach for distinguishing QD-stained cellular membranes from PI-stained nucleic acids in a single cell by tuning the ultrafast delay between IR and visible pulses. The color bars represent the counts on CCD pixels. FIG. 6A shows red-channel PL images of cells co-stained by both PI dyes and QDs.

FIG. 6B is a MD-WISE image of a co-stained cell when IR pulse is blocked. The dashed horizontal line indicates the location where linecut intensity analysis was performed. FIG. 6C is a normalized intensity plot aligned along the line in FIG. 6B, showing signals throughout the cell (shaded area). FIG. 6D MD-WISE difference PL image with delay t set to 1 ps, showing no contrast for PI and QD stains. FIG. 6E is a MD-WISE difference PL image with delay t set to −10 ps, showing negative contrast for QD-stained membranes. The dashed horizontal line indicates the location where linecut intensity analysis was performed.

FIG. 6F is a normalized intensity plot aligned along the line in FIG. 6E, showing signal peaks at the location of membranes (shaded area). All of the MD-WISE images in FIGS. 6B, 6D, and 6E were acquired using IR frequency centered at 2100 cm⁻¹, visible excitation at 550±5 nm, and PL collection wavelength range of 585±18 nm.

### DETAILED DESCRIPTION OF EMBODIMENTS

The inventive microscopy approach can distinguish chromophores that possess nearly identical emission spectra via conditions in a multidimensional space formed by three independent variables: the temporal delay between the infrared and the visible pulses (t), the wavelength of visible pulses (λᵥᵢₛ), and the frequencies of the infrared pulses (ω_{IR}). This method is enabled by two mechanisms: (1) modulating the optical absorption cross sections of molecular dyes by exciting specific vibrational functional groups and (2) reducing the PL quantum yield of semiconductor nanocrystals, which was achieved through strong field ionization of excitons. Importantly, the inventive MD-WISE microscopy operates under widefield imaging conditions with a field of view of tens of microns, other than the confocal configuration adopted by most nonlinear optical microscopies, which require focusing the optical beams tightly. By demonstrating the capacity of registering multidimensional information into PL images, MD-WISE microscopy has the potential of expanding the number of species and processes that can be simultaneously tracked in high-speed widefield imaging applications.

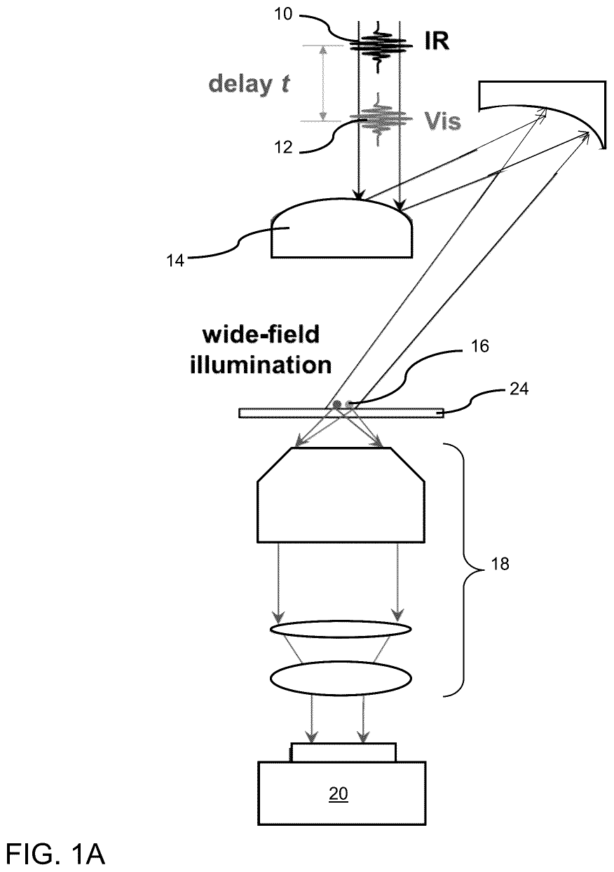

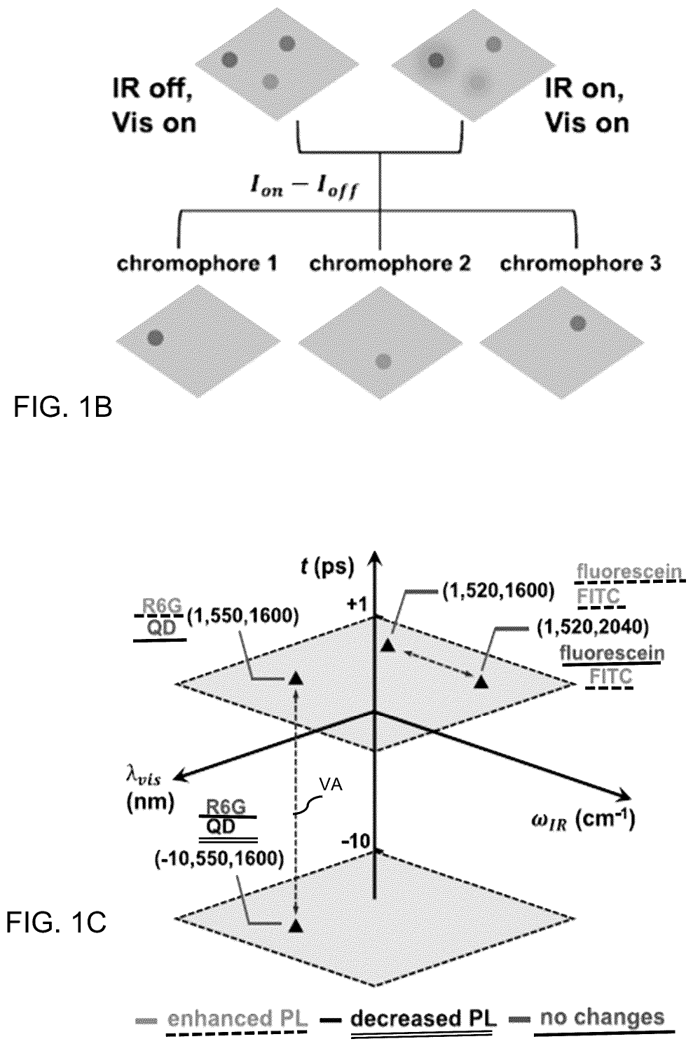

FIGS. 1A-1C diagrammatically illustrate the general approach and unique capability of MD-WISE microscopy. Referring to FIG. 1A, a pair of femtosecond IR and visible pulses 10 and 12 delayed by a controlled interval, t, travel collinearly and are spatially focused onto the sample of interest by a Schwarzchild reflective objective 14. (It should be noted that only the primary objective is shown in the figure.) The spontaneously emitted PL signals from the chromophores, following the ultrafast interactions of the two pulses, are collected by a refractive objective to form a widefield image on a charge-coupled device (CCD) camera 20. The intensity of the PL image is a function of the optical frequencies of the IR and visible pulses, as well as the temporal delay t. The visible pulse has a wavelength in a range from 300-800 nm. The temporal delay t between the IR pulse and the visible pulse may be within a range of from 1000 ps to 5000 ps. As shown in FIG. 1B, by taking the intensity difference of the PL images acquired with or without the IR pulse, difference images reveal species of which the PL is encoded by the IR pulse, either through vibrational excitation or strong field interactions.

Because the mechanisms that encode PL are time-dependent, MD-WISE realizes a three-dimensional condition space formed by the three orthogonal variables as illustrated in FIG. 1C: the IR frequency, the visible wavelength, and the ultrafast delay t. By choosing the appropriate condition in the space, many chromophores having nearly identical PL spectra or emitting in the same PL collection wavelength range can be distinguished in MD-WISE. By demonstrating the capacity of registering multi-dimensional information into widefield PL images, MD-WISE microscopy has the potential of further expanding the number of species and processes that can be simultaneously tracked in high-speed chemical and biological imaging applications.

### IR-Encoding Mechanism #1: Infrared-Visible Double-Resonance Process.

One of the two mechanisms of MD-WISE microscopy involves using vibrational excitation to alter the electronic absorption cross-section and the subsequent PL emission of molecular dyes. This type of double-resonance process has been previously investigated in various types of experiments that utilize mid-IR pulse to encode vibrational information into fluorescence signals. An eminent example is the broadband fluorescence-encoded IR spectroscopy that operates under the confocal configuration to read out the vibrational spectrum of coumarin molecules in the solution phase. In early work relating to widefield PL imaging, it was shown that in transient fluorescence detected IR microscopy, one can use fluorescence signals to image the spatial distribution of generic C—H and N—H stretch modes of dyes at the IR frequency of ˜3000 cm⁻¹. Nonetheless, the broad potential of multiplexed PL imaging has not been previously exploited. The inventive approach greatly expands the capabilities of this technique through the linking of vibrationally excited functional groups to various sites of dye molecules. These diverse groups can be used to differentiate nearly identical PL chromophores in widefield imaging.

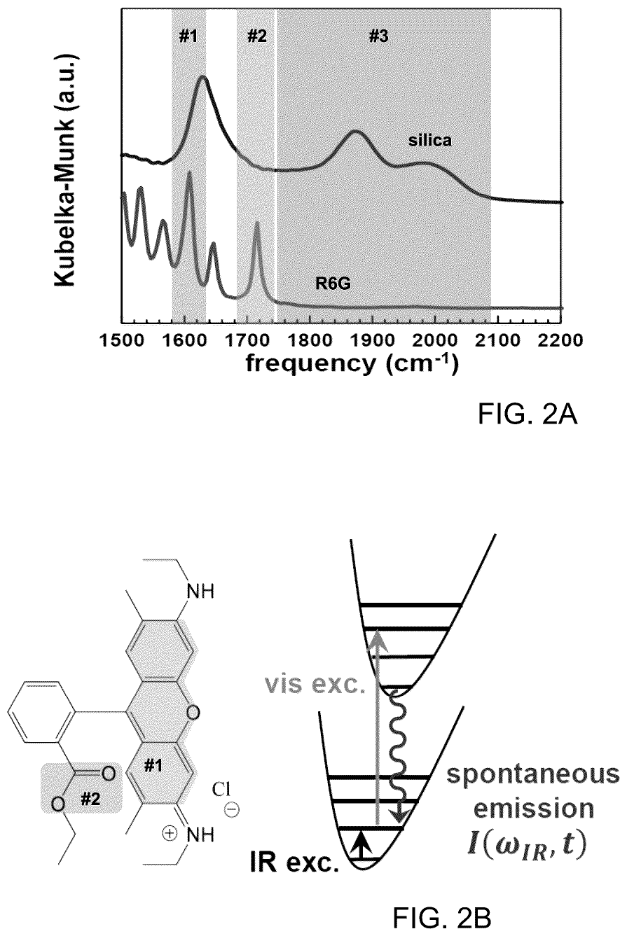

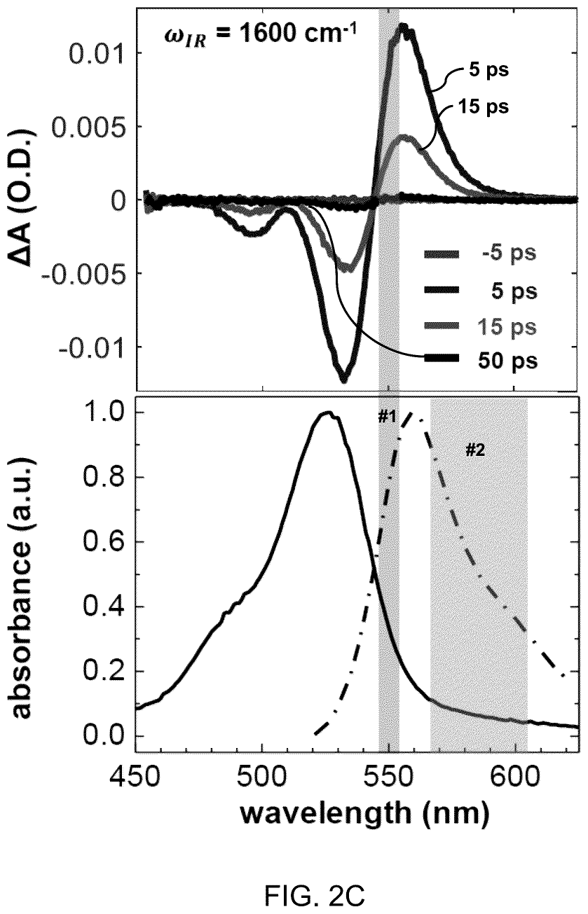

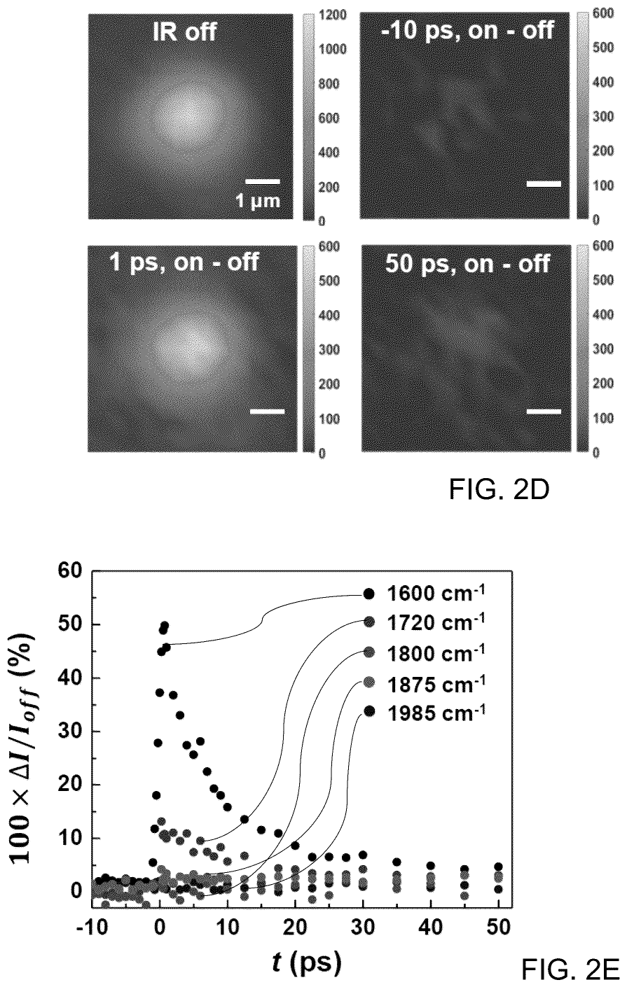

Rhodamine 6G (R6G) molecules, a prototypical fluorophore with a high fluorescence quantum yield (QY), is examined first. The solid-state linear IR absorption spectra of R6G (FIG. 2A), show a sharp peak at 1600 cm⁻¹, which is a ring stretch mode associated with the xanthene tri-ring conjugation system (shaded area #1), and a peak at 1720 cm⁻¹ that is assigned to the carbonyl stretch of the ester group (shaded area #2). Shaded area #3 indicates silica absorption. In the double-resonance excitation scheme here, the IR pulse first promotes a vibrational mode of R6G to the first excited state, v=1, shown in FIG. 2B where the shaded areas are labeled corresponding to those shown in FIG. 2A. Many vibrational modes of R6G could be involved in vibronic couplings. Due to the shift in energy levels and changes in Frank-Condon factors, the electronic absorption spectrum of v=1 state is altered from that of v=0 ground state. Therefore, the absorption cross-section of the visible photon at a specific wavelength change. Next, before vibrational relaxation, the visible pulse excites the molecules to S₁ electronically excited state. The absorption cross-section difference is read out through fluorescence, as the molecule returns to the ground state S₀. The QY of the fluorescence emission process is not affected by the IR excitation because the molecule, regardless of which vibronic state it is in immediately after the visible excitation, first relaxes to the lowest vibronic state in S₁ on an ultrafast timescale before emitting the fluorescence.

The effect of mid-IR excitation on the electronic absorption spectrum was verified by IR-pump-visible-probe transient absorption experiments. The upper panel of FIG. 2C displays the transient absorption spectra of R6G in de-dimethyl sulfoxide solution measured at several delays. The IR excitation is tuned to the xanthene stretch mode at 1600 cm⁻¹. For short delays such as 5 or 15 ps, it is evident that there is change in the absorbance across the visible spectrum, in contrast to the signal at negative delays or long delays such as 50 ps. Thus, the effect of IR excitation is an ultrafast double-resonance effect rather than a photothermal effect. At longer visible wavelengths, the sample exhibits a positive AA value, indicating the visible absorption is enhanced by IR excitation; on the contrary, the visible absorbance at shorter wavelength is reduced due to the bleaching of v=0 populations. Thus, when the IR excitation is on, it leads to increased absorption near 550 nm, which leads to increased fluorescence emission.

From the combined knowledge of transient and linear spectra (FIG. 2C), one can select a narrowband visible excitation wavelength centered at 550±5 nm (shaded area #1 in FIG. 2C) for MD-WISE imaging experiments. At 550 nm, there is a high AA to form a bright difference PL image, with sufficient low linear absorption (thus, low background PL) to achieve good signal-to-noise ratio. Furthermore, a 550 nm excitation has enough spectral shift from the PL detection window 585±18 nm (shaded area #2 in FIG. 2C) to eliminate leakage of excitation photons. The actual excitation and PL detection wavelengths of other dye molecules such as fluorescein could vary but are selected using the same criteria.

The next step is to examine the effect of IR excitations on widefield PL images. A set of widefield PL images of an R6G-stained microbead (diameter=3 microns) is displayed in FIG. 2D. The set includes an image collected without IR excitation (upper left) and several difference images collected with the delay t set to, moving clockwise, −10 ps, 1 ps, and 50 ps, respectively, with IR excitation range at 1600±30 cm⁻¹. The difference images are generated by subtracting the PL image without the IR pulse from the one with the IR pulse. At the short positive delay of 1 ps, the IR pulse enhances the emission signal strongly, because most of the vibrationally excited molecules have not relaxed yet. Furthermore, the difference image at 1 ps agrees with the no IR PL image, reflecting that it faithfully reproduces the shape of the microbead and the spatial distribution of R6G. In contrast, the microbead disappears in the difference images at −10 ps and 50 ps since the molecules have returned to the vibrational ground state.

To characterize the vibrational dynamics and the IR frequency dependence of PL encoding, the ultrafast kinetics of the PL intensity change for a series of IR excitation frequencies was measured (FIG. 2E). At a specific delay 1, the IR-induced change of PL intensity per CCD pixel, (Iₒₙ-I_{off})/I_{off}, can be calculated by averaging the relative intensity change among all the CCD pixels in a 2.5 μm by 2.5 μm box that centers around the microbead. Only when the IR frequency is tuned to the vibrational modes of R6G, the PL intensity is encoded. When the IR frequency center is tuned to 1800, 1875, 1985, 2050 and 2100 cm⁻¹ to cover the modes of silica in the range 1800-2100 cm⁻¹ (area #3 in FIG. 2A), the kinetic traces in FIG. 2E show no modulation or encoding signal. This indicates that exciting the silica substrate cannot change PL intensity. Thus, the IR-induced PL change originates from intramolecular processes. The extent of PL change differs among various vibrational modes of R6G. The highest occupied molecular orbital (HOMO) and lowest unoccupied molecular orbital (LUMO) of R6G are located on the xanthene ring conjugation system. Thus, it is expected that the 1600 cm⁻¹ vibrational mode of the xanthene has a stronger effect on the electronic absorption spectrum than the 1720 cm⁻¹ carbonyl stretch mode of the ester group. The carbonyl stretch mode is a relatively local mode involving mostly the displacements of ester group atoms, but it could couple with the displacements of the xanthene atoms.

The unexpected result that non-xanthene groups can affect PL intensity relaxes the conditions of where vibrational tags can be installed on chromophores and expands the possible library of chromophores for MD-WISE imaging.

### IR-Encoding Mechanism #2: Strong Field Ionization of Excitons in QDs.

The utility of the inventive approach can be further expanded beyond molecular fluorescence to PL emission of semiconductor nanocrystals. QD chromophores, which are semiconductor nanocrystals, are bright emitters of which the PL intensity can be encoded by an ultrafast IR pulse. However, the second mechanism is distinct from mechanism #1 discussed above. The IR-induced PL change of QDs originates from the strong electric field strength of an ultrafast mid-IR pulse which can drive electrons of excited-state QDs to overcome the potential barriers in core/shell QDs, leading to events such as the discharging of trion states and the dissociation of excitons. (See, e.g., J. Shi, et al., All-optical fluorescence blinking control in quantum dots with ultrafast mid-infrared pulses. Nat Nanotechnol 16, 1355-1361 (2021), incorporated herein by reference.) The low frequency phonon modes of inorganic nanocrystals are off-resonant from the IR frequencies (1600˜2100 cm⁻¹) used in this study, and thus do not interact with the IR pulse.

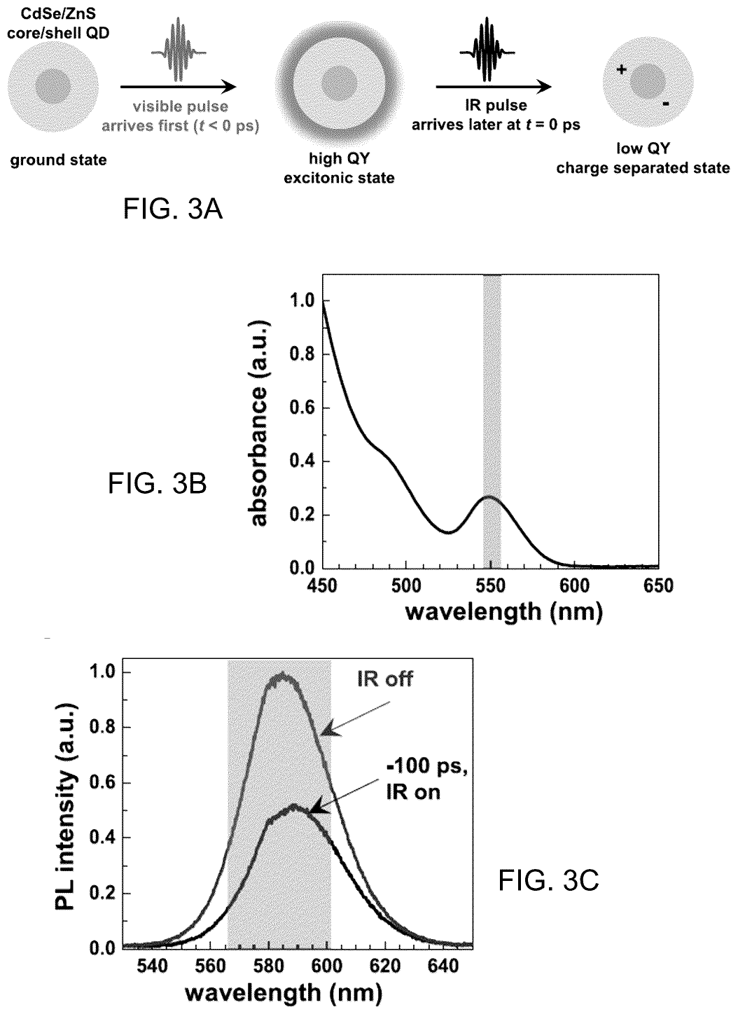

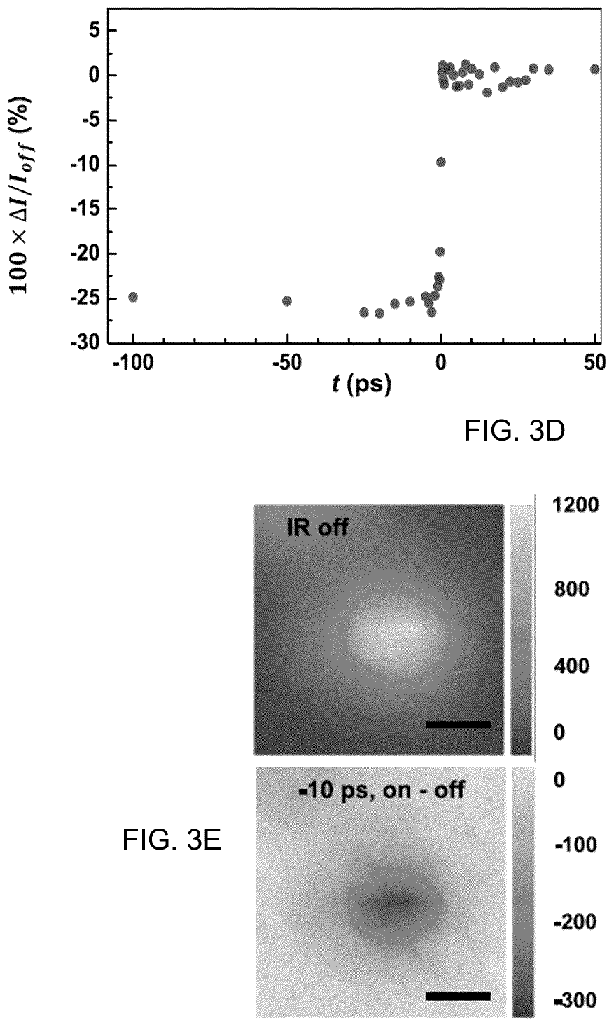

The encoding mechanism employed here is diagrammatically illustrated in FIG. 3A. First, the visible pulse excites the CdSe/ZnS core/shell QD into an excitonic state. If no IR pulse arrives, the exciton in QD would eventually emit a photon with a certain quantum yield (QY). If an IR pulse arrives before the emission occurs, the high electric field strength (˜50 MV/cm for the condition applied here) can dissociate the electron-hole pair of an exciton into separated charge carriers. The charge-separated state has a significantly lower QY for PL emission than the excitonic state, and therefore the action of the IR pulse quenches the PL intensity of a QD. This strong field effect of the IR pulse on QDs shares some similarities with the strong field ionization in atomic and molecular optics where an intense long wavelength laser pulse favors ionizations in atoms and molecules through tunneling ionizations and can drive the electrons further from the ionized atoms to mitigate recombination.

A 550±5 nm visible pulse (shaded area in FIG. 3B) was used to excite the first-excitonic absorption feature of the CdSe/ZnS QDs, then a strong IR pulse arrives. The frequency range of IR pulse is tuned to 2100±30 cm⁻¹, but the precise value can vary since the IR frequency is off-resonant: what matters is the electric field strength. In FIG. 3C, the PL spectra of QD-stained silica beads acquired with and without the IR pulse is plotted. The temporal delay t is −100 ps. It is evident that the PL intensity drops significantly and the PL spectrum redshifts due to the formation of low QY charge separated states following the action of the IR pulse. As shown in FIG. 3D, the quenching of PL intensity measured from MD-WISE images of QD-stained silica beads starts sharply as delay t becomes negative, i.e., when the IR pulse arrives later than the visible pulse. The relative change of PL intensity does not vary much from 1=−1 ps to −100 ps since the exciton lifetime of a QD is typically on the order of nanoseconds.

Phenomenologically, this IR-encoding mechanism significantly differs from the mechanism of dye molecules as it requires the opposite pulse sequence. The fact that the PL emission of molecular dyes is not subject to the electric field action of the IR pulse at negative delays could be due to the fact that the molecular excitons are more spatially confined and molecular energy levels are more discretely distributed than those of QDs. The inventive MD-WISE imaging takes advantage of the orthogonal behaviors of QDs and molecular dyes to demonstrate the concept of distinguishing chromophores solely by varying the delay t. This concept has been indicated by the vertical arrow VA in FIG. 1C.

The foregoing describes two distinct mechanisms to encode PL with ultrafast mid-IR pulses, which enable three-dimensional multiplexing (time, IR, and visible frequencies) of PL imaging. These provide the foundation of MD-WISE imaging. The following examples demonstrate the applications of both mechanisms.

### Example 1: Distinguishing Molecular Dyes by Tuning the IR Frequency

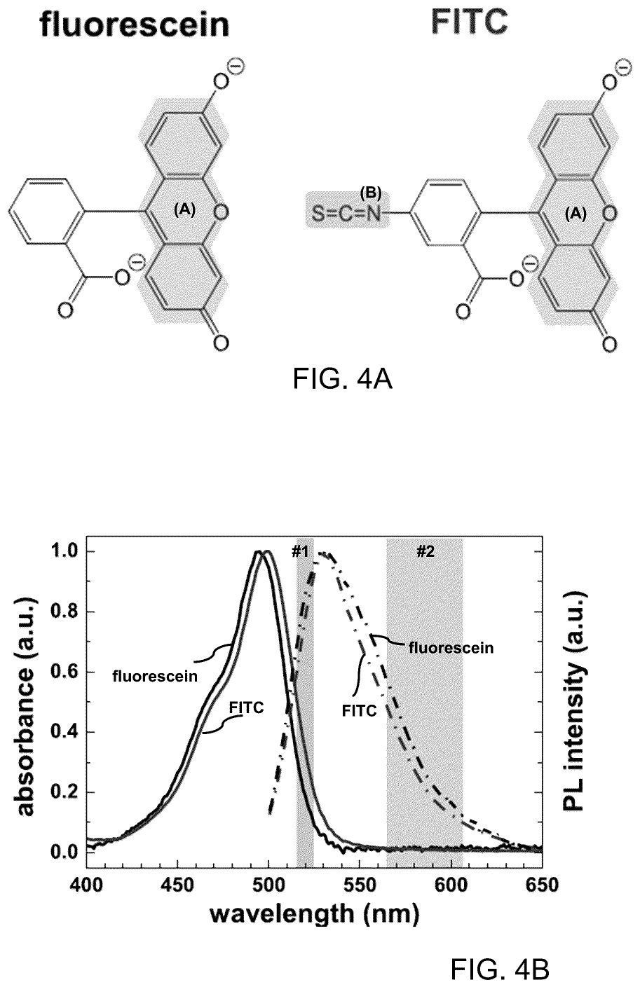

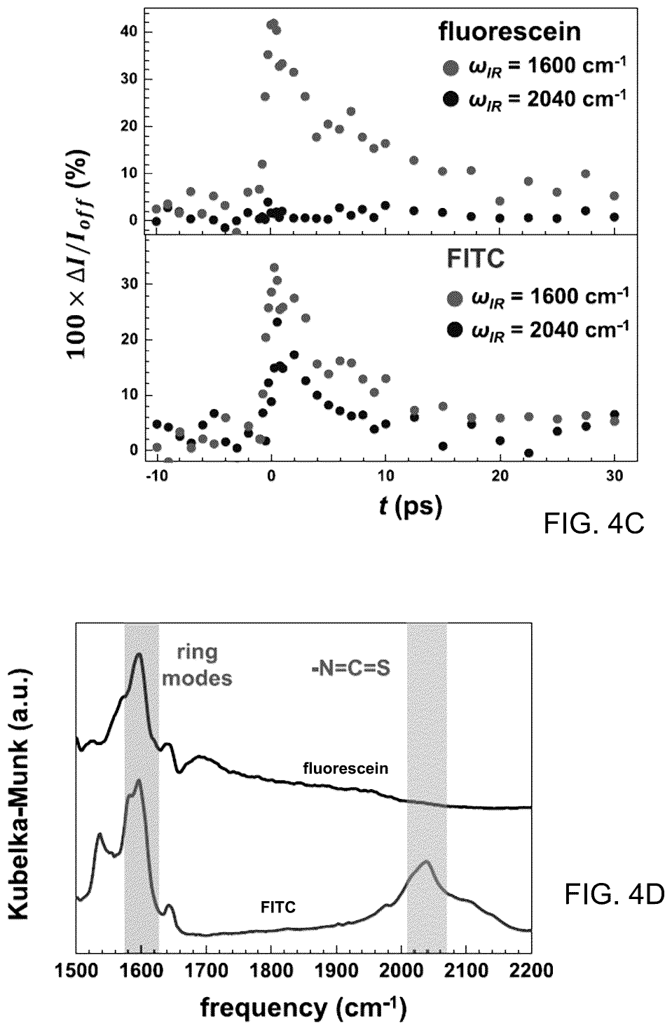

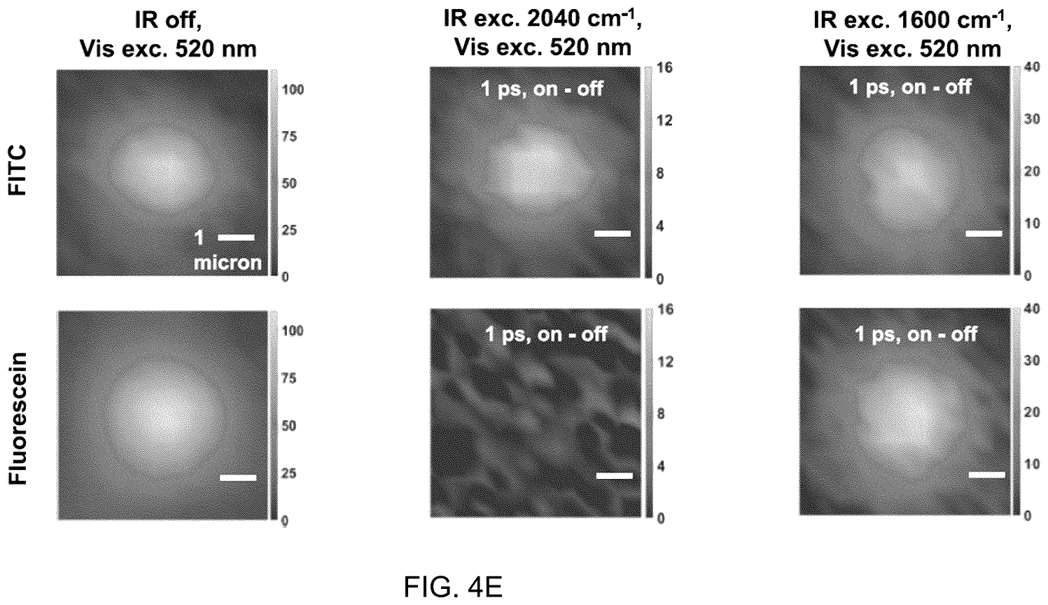

Two chromophores with nearly identical absorption and PL spectra can be distinguished using mid-IR vibrational excitations. The molecular dianion structures of fluorescein-5-isothiocyanate (FITC) and fluorescein, displayed in FIG. 4A, differ by one functional group: the isothiocyanate (—N═C═S) group. As shown in FIG. 4B, the two molecules have nearly identical electronic absorption and emission spectra, making it difficult to distinguish them by choosing specific excitation or emission wavelengths. In contrast, MD-WISE microscopy should distinguish FITC from fluorescein by exciting the asymmetric stretch mode of the —N═C═S group. The DRIFTS results of FITC and fluorescein (FIG. 4D) show that they both have the generic xanthene ring stretch at 1600 cm⁻¹ (shaded area (A) in FIG. 4A), and FITC has a unique isothiocyanate stretch mode at 2040 cm⁻¹ (shaded area (B)). The 2040 cm⁻¹ mode is accompanied by side bands that could be assigned to Fermi resonances between the —N═C═S stretch mode and the low frequency combination modes of the rings in FITC at ˜1000 cm⁻¹. Though the —N═C═S group is not directly attached to the xanthene rings, its stretch mode can affect PL intensity of the FITC dye, suggesting that the stretch mode could couple to the displacements of atoms in xanthene rings via Fermi resonances.

The effects of different vibrational modes on PL images are then investigated. The ultrafast kinetics of the PL intensity change of stained silica beads are plotted in FIG. 4C. When the IR frequency range is tuned to 1600±30 cm⁻¹, both FITC and fluorescein show significant IR-induced PL intensity change over the delay time range of 0˜10 ps. When the IR frequency range is tuned to 2040±30 cm⁻¹, only FITC shows PL intensity change. Comparing the percentage of PL change at fixed delays in the lower panel of FIG. 4, Panel D, the xanthene ring modes at 1600 cm⁻¹ have larger effects on the PL intensity than the —N═C═S stretch mode. This is expected because xanthene rings are directly responsible for the visible absorption and emission properties. However, the —N═C═S stretch mode encoding can be used to distinguish these two molecules.

Referring to FIG. 4E, FITC and fluorescence in microbeads can be differentiated by IR excitations in widefield MD-WISE images. The left column shows the PL images without applying the IR pulse. The middle and the right columns show the difference images acquired at short delay time of 1 ps using IR center frequencies of 1600 and 2040 cm⁻¹, respectively. Using 2040 cm⁻¹ IR excitation, it is evident that only the FITC-stained bead appears in the difference image while the fluorescein-stained bead is invisible. In contrast, the 1600 cm⁻¹ excitation causes beads dyed by both molecules to be visible. Thus, in addition to the example of the ester group in R6G molecule discussed above, the —N═C═S group on FITC marks another case where vibration of a functional group not attached to the xanthene rings can affect the PL emission. The results here demonstrate that nearly identical dyes can be used for multiplexing through their distinction in vibrational modes. The large IR absorption cross-section enables the IR-encoded PL images to be acquired in a widefield manner. Here, using relatively low pulse energies, 0.4 μJ of IR and 0.25 nJ of visible pulses, images with a field of view of up to 20 microns can be acquired without raster scanning.

### Example 2: Distinguishing QDs from Molecular Dyes by Tuning the Ultrafast Delay Between Pulses

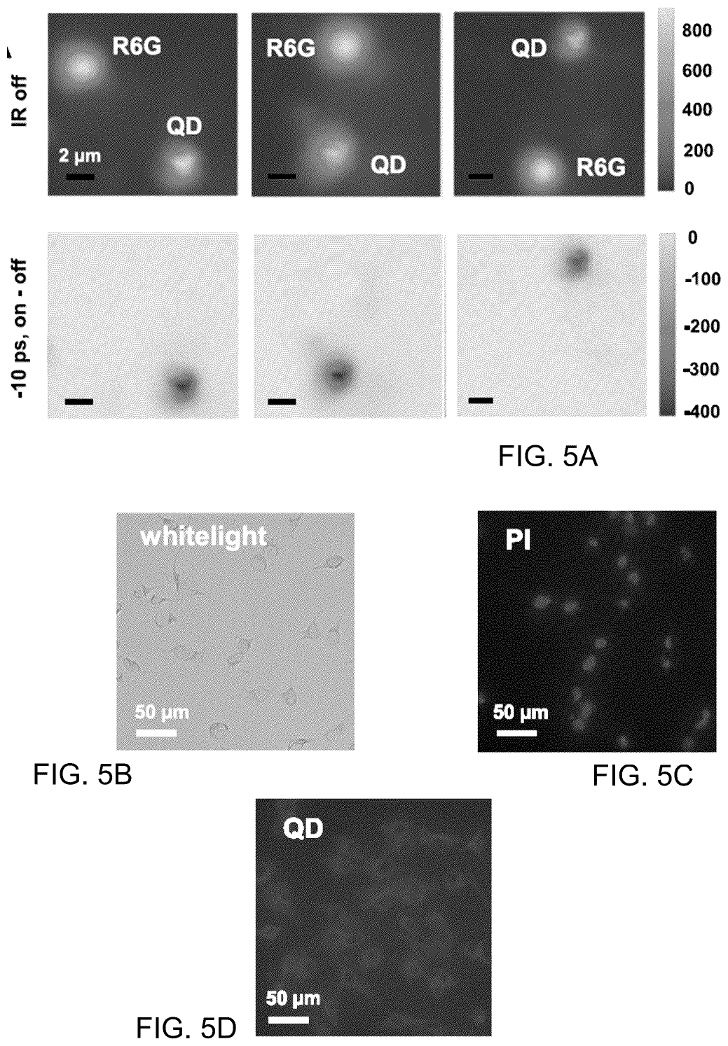

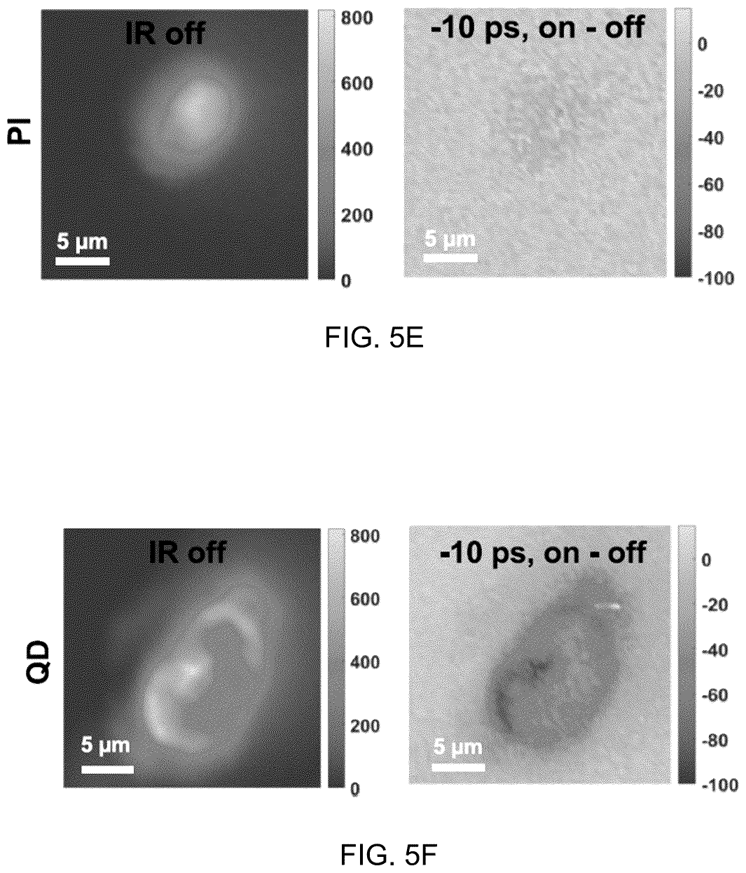

The PL emission of QDs and molecules require opposite pulse sequences to encode the IR interactions. In MD-WISE imaging, the orthogonal behaviors of QDs and molecular dyes can be exploited to distinguish chromophores solely by varying the delay t. FIG. 5A shows the PL images of mixed silica beads. The smaller 2-micron beads are stained with QDs and the larger 3-micron beads are stained with R6G molecules. Both types of beads can be captured within the same view. The PL collection wavelength window covers the emission spectra of both QDs and R6G molecules. The IR frequency center is tuned to the 1600 cm⁻¹ xanthene ring mode of R6G, while there is no frequency requirement to encode the PL of QDs. At t=−10 ps, the R6G-stained beads disappear from the difference images in the bottom row of FIG. 5A, while QD-stained beads remain due to the significant quenching of PL intensity by the IR pulse. The orthogonal encoding behaviors of QDs and molecular dyes suggest that, for almost any emission color, a QD with a matching bandgap can be chosen to act as the counterstain for the molecular dyes that emit the same color in PL imaging.

QD chromophores are known to be bright PL emitters for biological imaging. The inventive MD-WISE approach can be used to differentiate QDs and molecular dyes in biological samples. The white light bright field images and conventional PL images of fixed human breast cancer cells are shown in FIGS. 5B-5D. The cells are either stained by the QDs coated with streptavidin to visualize the cell membrane (FIG. 5D) or the molecular dye propidium iodide (PI) to visualize the cell nucleus (FIG. 5C). Although the chromophores now are separated in the cells by their binding specificities to different biological structures, both the QD and the PI dye emit in the red channel of a conventional widefield PL microscope, and thus cannot be simply distinguished by PL emissions if there is no prior knowledge of the binding properties. To differentiate them, the 2100±30 cm⁻¹ IR excitation pulse was applied following the visible pulse, followed by detection of the change of PL emissions of both the QDs and the PI dyes. The IR frequency was selected in the cell-silent IR region to avoid excess IR absorption by water and biomolecules in the cells. Referring to FIG. 5E, although the regular PL image shows the cell nucleus, the difference image acquired at −10 ps appears blank, indicating that there is no IR-induced PL change at this negative delay, verifying that the cell nucleus is stained by PI dyes. In FIG. 5F, the −10 ps difference image reproduces well the shape of the cell membrane as seen in the PL image acquired without the IR pulse, verifying that QDs coated with streptavidin only stain the cell membrane. These results demonstrate that the multiplexed MD-WISE microscopy can distinguish QD and molecular dyes as counterstains to each other by purely optical means even though these chromophores emit at the same detection channel.

### Example 3: Distinguishing Cellular Components within the Same Cell Using MD-WISE

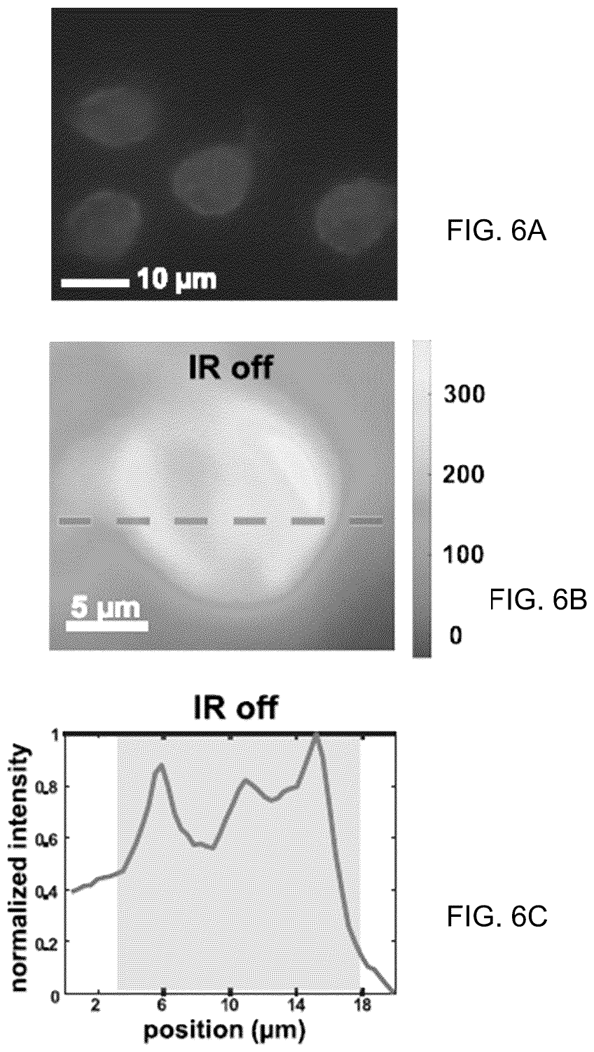

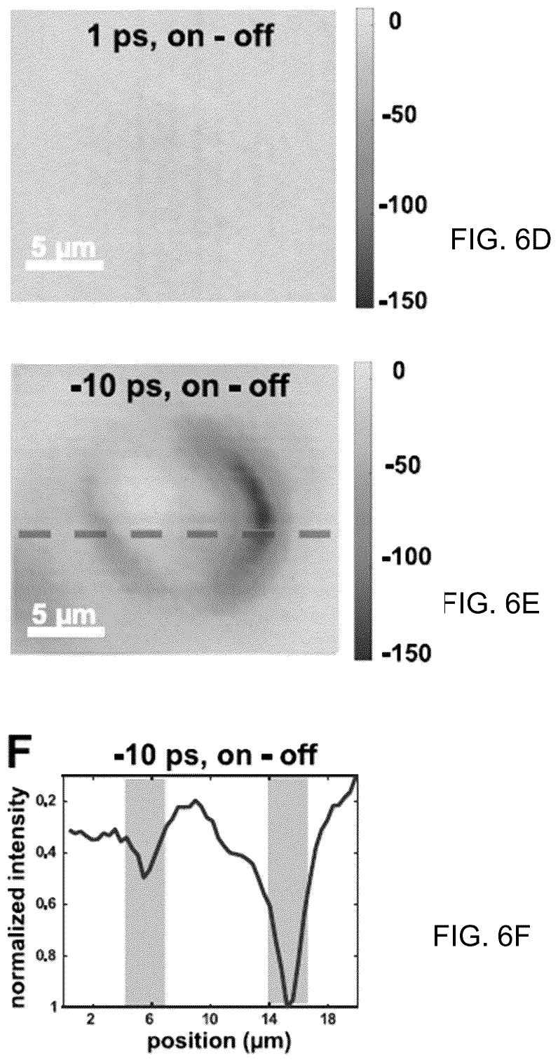

Cells co-stained by both the QD and PI chromophores were examined to determine the ability of the inventive approach to distinguish between cellular components in the same cell. Referring to FIG. 6A, both the interior of the cells and cellular membranes appear as stained under the red channel of a conventional widefield PL microscope. FIG. 6B shows the MD-WISE image of a co-stained cell when the IR pulse is blocked, which appears similar to the cells shown in FIG. 6A. To clearly visualize various components in the image, a linecut was made through the image and the normalized pixel intensity across the image was analyzed. The normalized intensity plot in FIG. 6C shows that PL signals are observed throughout the cell, i.e., including the cell nucleus and membranes. In contrast, when the 2100 cm⁻¹ IR pulse is applied, the MD-WISE difference PL image at delay t=−10 ps selectively resolves the QD-stained cell membranes. The membranes show negative contrast in FIG. 6E due to the PL quenching effect of the IR pulse, while the nucleic acids stained by PI show no contrast. The normalized linecut intensity plot in FIG. 6F shows only two major peaks corresponding to the boundaries of the QD-stained membranes. As a control experiment, the MD-WISE difference PL image at t=1 ps in FIG. 6D shows only the expected blank image, since the IR pulse neither is tuned to the resonant vibrational frequency of the PI molecular dye nor is able to affect the emission intensity of QDs when it arrives earlier than the visible pulse. Thus, the MD-WISE images can be used to differentiate various components of a single cell stained by chromophores emitting in the same wavelength range and are nearly free from any photothermal background. In some applications, one color channel can be used to simultaneously monitor the shape and status of both cell membranes and the nucleus while saving other color channels for purposes such as imaging the glycosylation on the cell surface or drug delivery across membranes. Using the multidimensional “colors” in MD-WISE imaging thus allows discovery of intricated connections between biological events and the complex interplays among biomolecules.

### Example 4: Materials and Test Procedures

Materials. R6G, FITC, fluorescein, PI (propidium iodide) dyes, and mesoporous silica microspheres were purchased from Sigma-Aldrich (St. Louis, MO). Streptavidin-coated QDs (emission max 585 nm, catalog no. Q10111MP), sulfo-NHS—SS-biotin (Catalog no. A39258) were purchased from Thermo Fisher (Waltham, MA). Ammine-coated CdSe/ZnS QD aqueous solutions were purchased from NN-Labs (Fayetteville, AR) (Catalog no. HECZWA560). All chemicals and materials were used as purchased without further purification.

Staining of silica microbeads. For the staining of silica microbeads with molecular dyes, dyes were diluted into ˜1 mg/mL solutions (chloroform for R6G, ethanol for fluorescein and FITC), then the silica microbeads were soaked in the solutions and filtered. For fluorescein and FITC, 2 equivalent of NaOH (dissolved in ethanol) were added to form the bright dianions before adding the silica beads. For the staining using ammine-coated CdSe/ZnS QDs, QDs were diluted into 0.1 mg/mL aqueous solutions, the silica microbeads were then soaked in the solutions after which the water was removed by a rotary evaporator.

### Staining of Fixed Cells:

QD staining. MDA-MB-231 human breast cancer cells (HTB-26) were obtained from American Type Culture Collection (ATCC; Manassas, VA) and cultured in Dulbecco's Modified Eagle's medium (Gibco, Waltham, MA) supplemented with 10% fetal bovine serum (Sigma-Aldrich, St. Louis, MO) at 37° C. in a humidified incubator with 5% CO₂. The cells growing on coverslips at ˜60% confluence were washed three times with phosphate-buffer saline (PBS) solutions at pH=8.0. Then 250 μL PBS containing 0.5 mg/mL sulfo-NHS—SS-Biotin (freshly made) was added. The cells were incubated at room temperature for 30 minutes, then washed three times with ice-cold PBS. Cells were fixed in 100% cold methanol for 10 min at −20° C. then washed three times with PBS (5 min/wash). 250 μL PBS containing 40 nM streptavidin-coated QDs were added to the cells which were then incubated for 1 hour at room temperature, washed three times with PBS, then rinsed with water.

PI staining. The cells growing on coverslips at ˜60% confluence were washed three times with phosphate-buffer saline (PBS) solutions at pH=8.0. Cells were fixed in 100% cold methanol for 10 min at −20° C., then washed three times with PBS (5 min/wash). The washed cells were rinsed using 2× saline sodium citrate (SSC, 0.3 M NaCl, 0.03 M sodium citrate, pH 7.0) solutions. 250 μL of 500 μM PI solution (diluting 1.5 mM stock aqueous solution using 2×SSC) were added. The cells were incubated for 15 minutes then rinsed three times with 2×SSC, followed by rinsing with water. The bright field whitelight images and red-channel PL images were examined using a BZ—X710 microscope (TRITC red channel: excitation filter 540/25 nm, emission filter 605/70 nm, center/width).

Linear optical measurements. Diffuse reflectance infrared Fourier transform spectroscopy (DRIFTS) measurements were acquired using a Thermo Fisher Nicolet iS10 spectrometer by mixing the samples with KBr matrix. Linear UV/visible absorption spectra of stained beads were acquired using a Cary 60 spectrophotometer (Agilent Technologies, Santa Clara, CA). Linear PL emission spectra of stained beads were acquired on a Hamamatsu Quantaurus-QY C11347 spectrometer (Hamamatsu Photonics, Bridgewater, NJ). For UV/visible and PL measurements of the stained microbeads, the microbeads were sandwiched between two No.5 thin coverslips (Zeiss, 170±5 microns) with transparent fluorolube oil to minimize scattering.

Laser systems. The ultrafast pulses (IR and visible) used in the experiments were produced using an Yb-based amplifier (Carbide, Light Conversion) pumping an optical parametric amplifier (Orpheus-One, Light Conversion) system. In some embodiments, the repetition rate of the laser was in a range of 1 to 20 kHz. In other embodiments, the repetition rate may be in a range from 1 to 1,000 kHz. The femtosecond laser is used to pump one or more optical parametric amplifiers (OPA) to produce the IR and visible pulses which are wavelength-tunable and have sufficiently high pulse energies to generate high quality widefield PL images.

The mid-IR pulse was produced by the difference frequency generation crystal in the optical parametric amplifier, and the frequency center was tuned within the range of 1600˜2100 cm⁻¹ depending on the need. The spectral full width at half maxima (FWHM) of the mid-IR output was ˜60 cm⁻¹. For the non-biological samples, the mid-IR pulse energy was set to 0.4 microjoules using a pair of half-wave plate and polarizer. For the imaging of cells with a larger field of view (˜30 microns), the mid-IR pulse energy used was 1.5 microjoules. The visible pulse for electronic excitation was generated by spectrally filtering a whitelight pulse, which was generated by focusing the optical parametric amplifier's 725 nm visible output into an yttrium aluminum garnet (YAG) crystal. For example, the 550±5 nm visible pulse was obtained by passing the whitelight pulse through a 550±5 nm bandpass filter. The visible pulse energy after the filter was very low, estimated to be about only 0.25 nJ, equivalent to 5 microwatts at 20 kHz repetition rate. A long exposure time of several seconds was used for the MD-WISE imaging experiments described herein, however the exposure time is not an intrinsic limiting factor for the MD-WISE method. The duration of the IR and visible pulses were determined as <300 femtoseconds by cross-correlation experiments. For the experiments below, the IR and visible pulses were combined collinearly using a customized dichroic mirror that reflects the visible pulse and transmits the IR pulse. The delay between the two pulses was controlled by a mechanized delay stage (Newport, XMS160). It should be noted that the specific examples described herein are not intended to be limiting. For example, the foregoing examples specify a visible wavelength of 550±5 nm, which is the wavelength corresponding to the specified chromophore. In general, the visible pulse will be within a wavelength range of 300-800 nm, and selection of the appropriate wavelength for a given chromophore will be within the level of skill in the art.

### IR-Pump Whitelight-Probe Ultrafast Transient Absorption Experiments.

R6G was dissolved in do-dimethyl sulfoxide and the solution was sandwiched between two CaF₂ windows with a 56-micron spacer. Referring to FIG. 1A, the whitelight pulse 12 and the mid-IR pulse 10 were collinearly focused into the solution by a Schwarzchild reflective objective 14 (Thorlabs, LMM40X—P01, numerical aperture 0.5). The beam size of both pulses at the focus was measured as 10˜15 microns using a knife-edge method. The IR pulse was chopped by an optical chopper at 1 KHz. The whitelight pulse passing through the sample was collimated and attenuated by optical assembly 18 before entering a spectrograph (300 1/mm grating, Shamrock 500i, Oxford Instruments) equipped with a conventional CCD detector 20 (Newton 920, Oxford Instruments). The CCD detector's framerate was synchronized with the chopper at 1 KHz to collect the whitelight spectra when the IR pulse was blocked or unblocked, and the change of optical density induced by IR pulse, AA, can be calculated at each wavelength. Transient absorption spectra were acquired at a series of temporal delays.

MD-WISE imaging experiments. The stained samples 16 were placed on a No.5 thin coverslip 24 (Zeiss, 170±5 microns). The coverslip was mounted on a 2D piezo stage (MadCity Labs) (not shown). The filtered visible pulse and the mid-IR pulse were focused onto the sample by a Schwarzchild reflective objective 14 (PIKE Technologies Inc., PN 891-0001, numerical aperture 0.7). The field of view was adjustable, typically 10˜20 microns for the imaging of silica microbeads and 30˜40 microns for the imaging of fixed cells.

The PL signals emitted by the chromophores passed through the coverslip 24 and were collected by an infinity corrected 20× refractive objective (Zeiss, Fluar, numerical aperture 0.75). The PL signals then passed through a bandpass filter to remove the visible excitation pulse and were projected directly on the Newton 920 CCD 20 to form widefield images. The difference images in MD-WISE experiments were formed by subtracting the PL image collected when the IR beam was blocked by a mechanical shutter (IR off) from the PL image collected when the IR beam was unblocked (IR on). The CCD acquisition time was set to 1˜10 seconds for each image collected with the IR beam on or off, depending on the brightness of the sample.

The foregoing description demonstrates the inventive scheme for distinguishing chromophores in widefield PL imaging using independently tunable parameters such as the IR frequency and the ultrafast temporal delay in a three-dimensional multiplexed condition space. In some embodiments, the inventive approach allows visual distinction of cells co-stained with chromophores comprising quantum dots (QDs) and molecular dyes with overlapping PL spectra objects using widefield imaging. The QDs and molecular dyes can be distinguished by adjusting the temporal delay between the mid-infrared and visible pulses. The orthogonal responses of chromophores to an ultrafast IR pulse are not limited to the illustrative examples described herein and can in principle be applied to distinguish other chromophores that have significantly overlapping emission spectra. The

Accordingly, based on the examples described herein, it will be apparent to those of skill in the art that highly multiplexed imaging is feasible if many chromophores are created with proper designs for MD-WISE, providing for the construction of a library for simultaneous labeling and visualizing chemical species in complex systems. To distinguish chromophores using different IR excitation frequencies, functional groups with distinct vibrational frequencies, such as isothiocyanate, nitrile, or azide groups, can be installed on bright fluorophores such as xanthene or cyanine dyes.

The effectiveness of vibronic coupling between vibrational tagging groups and electronic transitions has a direct impact on the imaging quality of the MD-WISE method. Vibrational tags covalently bonded to the conjugated emissive ring of dye molecules tend to have strong vibronic coupling effects. The inventive approach provides significant flexibility in the chemical sites where vibrational tags can be linked to fluorophores, simplifying the strategy and requirement for synthesize multiplexed palettes of fluorophores distinguishable by vibrational modes. Vibronic coupling over long distances, such as the effect of the ester group on the emission of R6G and the effect of the isothiocyanate group on the emission of FITC, is feasible. The design of dye toolkits for MD-WISE imaging depends on understanding vibronic coupling mechanisms and discovering new coupling pathways, as it can further expand the approach to distinguish chromophores. For example, using vibrational modes with different enough lifetimes can allow a significant portion of one chromophore to remain in the vibrational excited state and be seen by MD-WISE while the other chromophore has largely returned to the vibrational ground state. Different vibrational lifetimes of the same dye may also be used to infer the differences in local chemical environments within cells, tissues, or fabricated chemical devices. These extensions require key knowledge of the IVR pathways. Besides molecular probes for MD-WISE imaging, it is also feasible to design QD probes that show tailored responses to the electric field of IR pulses.

It is important to note that femtosecond IR pulses are preferred over picosecond IR pulses in the inventive MD-WISE method for good reason. Femtosecond pulses are critical for generating the high electric field needed for modulating the PL of QDs. Furthermore, femtosecond pulses offer a better opportunity to distinguish vibrational modes of which the lifetime is often only a few picoseconds. It may appear that picosecond IR pulses possess a narrower bandwidth and better spectral selectivity than femtosecond IR pulses. However, equipment such as a simple Fabry-Perot cavity or an acoustic-optical modulator can convert the broad spectrum of a femtosecond IR pulse to a narrowband spectrum or even an arbitrary spectrum, offering a general strategy to encode the IR excitation process. For example, the bandwidth of a femtosecond IR pulse can be edited to only excite one vibrational mode when the full bandwidth can cover multiple modes.

Additional possibilities opened by the inventive approach include multiplexed widefield PL imaging without using requiring exogeneous PL chromophore labels but rather using intrinsic PL such as the autofluorescence of the sample. The ability to image the intrinsic chemical species in a microscopic sample is central to understanding and interacting with physical and biological systems. The inventive provides a solution to existing obstacles to such understanding, for example, the autofluorescence of multiple species in biological samples often have overlapping emission spectra. To enable multiplexed chemical PL imaging, MD-WISE method can either use the intrinsic vibrational modes of fluorescent biomolecules or the vibrational modes of modified molecules such as a tryptophan tagged with a small, nonperturbative vibrational label.

While it may also be noted that the vibrational absorption of water causes the penetration depth of the mid-IR beam in water to be typically less than a few tens of microns, this does not limit the biological application of MD-WISE imaging. Widefield imaging is most useful for thin samples such as cells and sectioned tissues that do not have severe water absorption background. Aqueous buffer solutions can be confined between coverslips to form thin liquid films that are penetrable by the mid-IR beam. Furthermore, in the epifluorescence imaging geometry, the short IR penetration depth in water can be utilized to confine the focusing depth of IR and thus improve the three-dimensional imaging contrast and resolution of the IR-modulated PL signal of MD-WISE imaging.

While the current MD-WISE microscopy was demonstrated using a conventional CCD imaging without electron-multiplying (EM) capacity, and the visible excitation power is only ˜0.25 nJ, there is significant space for improvements in sensitivities, which can be straightforwardly achieved through the use of more sensitive detectors and more powerful visible excitation lasers. For PL detection in the visible wavelength region, single particle or single molecule level sensitivity can be achieved routinely using an EM-CCD or avalanche photodiode detector.

Since the relative change of PL intensity induced by the IR pulse can reach tens of percents at short delays without photothermal background and MD-WISE is based on the resonant excitation of the chromophore itself, the ultimate sensitivity limit of MD-WISE microscopy has the ability to approach or even attain the single-molecule level when using highly sensitive detectors, opening the possibility of highly multiplexed super-resolution PL imaging.

It is worth noting that the relative PL intensity change in MD-WISE imaging is related to the field of view, since the photon flux of IR excitation is inversely proportional to the size of the illuminated area, widefield imaging requires high energy for each IR pulse that modules the PL intensity. The inventive approach benefits from the usage of kHz optical parametric amplifier (OPA) systems. The low-repetition-rate OPA systems generally produce a much higher pulse energy than the high-repetition-rate OPO systems. Using an IR pulse energy of 1.5 microjoules allows the acquisition of images with a field of view of ˜30 microns. Given that many cells have dimensions near or smaller than 30 μm, the current widefield imaging technique has a practical importance to image a whole cell without rastering or stitching images. Higher IR pulse energy from an OPA system, e.g., 20 μJ, can potentially enable a field of view >100 μm and higher imaging speed in widefield imaging.

Overall, the development of new PL probes and improvement of excitation and detection conditions for MD-WISE microscopy provides highly sensitive multidimensional information acquisition on complex biological and chemical systems and enable the well-established kHz laser systems to contribute to biomedical imaging applications.

### REFERENCES (INCORPORATED HEREIN BY REFERENCE)

1. W. E. Moerner, M. Orrit, Illuminating Single Molecules in Condensed Matter. Science (1979) 283, 1670-1676 (1999).
2. S. Nie, D. T. Chiu, R. N. Zare, Probing Individual Molecules with Confocal Fluorescence Microscopy. Science (1979) 266, 1018-1021 (1994).
3. S. W. Hell, J. Wichmann, Breaking the diffraction resolution limit by stimulated emission: stimulated-emission-depletion fluorescence microscopy. Opt. Lett. 19, 780-782 (1994).
4. E. Betzig, et al., Imaging Intracellular Fluorescent Proteins at Nanometer Resolution. Science (1979) 313, 1642-1645 (2006).
5. M. J. Rust, M. Bates, X. Zhuang, Sub-diffraction-limit imaging by stochastic optical reconstruction microscopy (STORM). Nat Methods 3, 793-796 (2006).
6. S. B. Penwell, L. D. S. Ginsberg, R. Noriega, N. S. Ginsberg, Resolving ultrafast exciton migration in organic solids at the nanoscale. Nat Mater 16, 1136-1141 (2017).
7. J. Seo, et al., PICASSO allows ultra-multiplexed fluorescence imaging of spatially overlapping proteins without reference spectra measurements. Nat Commun 13, 2475 (2022).
8. K. Chen, R. Yan, L. Xiang, K. Xu, Excitation spectral microscopy for highly multiplexed fluorescence imaging and quantitative biosensing. Light Sci Appl 10, 97 (2021).
9. C. W. Freudiger, et al., Label-Free Biomedical Imaging with High Sensitivity by Stimulated Raman Scattering Microscopy. Science (1979) 322, 1857-1861 (2008).
10. A. Zumbusch, G. R. Holtom, X. S. Xie, Three-Dimensional Vibrational Imaging by Coherent Anti-Stokes Raman Scattering. Phys Rev Lett 82, 4142-4145 (1999).
11. Y. Bai, et al., Ultrafast chemical imaging by widefield photothermal sensing of infrared absorption. Sci Adv 5, eaav7127 (2023).
12. Y. Zhang, et al., Fluorescence-Detected Mid-Infrared Photothermal Microscopy. J Am Chem Soc 143, 11490-11499 (2021).
13. M. Li, et al., Fluorescence-Detected Mid-Infrared Photothermal Microscopy. J Am Chem Soc 143, 10809-10815 (2021).
14. A. Gaiduk, P. v Ruijgrok, M. Yorulmaz, M. Orrit, Detection limits in photothermal microscopy. Chem Sci 1, 343-350 (2010).
15. H. Xiong, et al., Stimulated Raman excited fluorescence spectroscopy and imaging. Nat Photonics 13, 412-417 (2019).
16. H. Xiong, et al., Super-resolution vibrational microscopy by stimulated Raman excited fluorescence. Light Sci Appl 10, 87 (2021).
17. A. Mau, K. Friedl, C. Leterrier, N. Bourg, S. Lévêque-Fort, Fast widefield scan provides tunable and uniform illumination optimizing super-resolution microscopy on large fields. Nat Commun 12, 3077 (2021).
18. Y. Guo, et al., Visualizing Intracellular Organelle and Cytoskeletal Interactions at Nanoscale Resolution on Millisecond Timescales. Cell 175, 1430-1442.e17 (2018).
19. M. Delor, H. L. Weaver, Q. Yu, N. S. Ginsberg, Imaging material functionality through three-dimensional nanoscale tracking of energy flow. Nat Mater 19, 56-62 (2020).
20. K. Ishii, S. Takeuchi, T. Tahara, Infrared-induced coherent vibration of a hydrogen-bonded system: Effects of mechanical and electrical anharmonic couplings. J Chem Phys 131, 044512 (2009).
21. E. A. Arsenault, P. Bhattacharyya, Y. Yoneda, G. R. Fleming, Two-dimensional electronic-vibrational spectroscopy: Exploring the interplay of electrons and nuclei in excited state molecular dynamics. J Chem Phys 155, 020901 (2021).
22. L. J. G. W. van Wilderen, A. T. Messmer, J. Bredenbeck, Mixed IR/Vis Two-Dimensional Spectroscopy: Chemical Exchange beyond the Vibrational Lifetime and Sub-ensemble Selective Photochemistry. Angewandte Chemie International Edition 53, 2667-2672 (2014).
23. J. C. Wright, Double Resonance Excitation of Fluorescence in the Condensed Phase—An Alternative to Infrared, Raman, and Fluorescence Spectroscopy. Appl. Spectrosc. 34, 151-157 (1980).
24. M. Sakai, Y. Kawashima, A. Takeda, T. Ohmori, M. Fujii, Far-field infrared super-resolution microscopy using picosecond time-resolved transient fluorescence detected IR spectroscopy. Chem Phys Lett 439, 171-176 (2007).
25. T. Ohmori, M. Sakai, M. Ishihara, M. Kikuchi, M. Fujii, Cell imaging by transient fluorescence detected infrared microscopy in Proc.SPIE, (2008), p. 685307.
26. N. Bokor, K. Inoue, S. Kogure, M. Fujii, M. Sakai, Visible-super-resolution infrared microscopy using saturated transient fluorescence detected infrared spectroscopy. Opt Commun 283, 509-514 (2010).
27. K. Inoue, N. Bokor, S. Kogure, M. Fujii, M. Sakai, Two-point-separation in a sub-micron nonscanning IR super-resolution microscope based on transient fluorescence detected IR spectroscopy. Opt Express 17, 12013-12018 (2009).
28. J. Hebling, K.-L. Ych, M. C. Hoffmann, B. Bartal, K. A. Nelson, Generation of high-power terahertz pulses by tilted-pulse-front excitation and their application possibilities. Journal of the Optical Society of America B 25, B6-B19 (2008).
29. C. Manzoni, M. Först, H. Ehrke, A. Cavalleri, Single-shot detection and direct control of carrier phase drift of midinfrared pulses. Opt Lett 35, 757-759 (2010).
30. J. Shi, et al., All-optical fluorescence blinking control in quantum dots with ultrafast mid-infrared pulses. Nat Nanotechnol 16, 1355-1361 (2021).
31. A. Seilmeier, W. Kaiser, A. Laubereau, S. F. Fischer, A novel spectroscopy using ultrafast two-pulse excitation of large polyatomic molecules. Chem Phys Lett 58, 225-229 (1978).
32. J. N. Mastron, A. Tokmakoff, Fourier Transform Fluorescence-Encoded Infrared Spectroscopy. J Phys Chem A 122, 554-562 (2018).
33. L. Whaley-Mayda, A. Guha, S. B. Penwell, A. Tokmakoff, Fluorescence-Encoded Infrared Vibrational Spectroscopy with Single-Molecule Sensitivity. J Am Chem Soc 143, 3060-3064 (2021).
34. L. Whaley-Mayda, A. Guha, A. Tokmakoff, Resonance conditions, detection quality, and single-molecule sensitivity in fluorescence-encoded infrared vibrational spectroscopy. J Chem Phys 156, 174202 (2022).
35. L. Whaley-Mayda, S. B. Penwell, A. Tokmakoff, Fluorescence-Encoded Infrared Spectroscopy: Ultrafast Vibrational Spectroscopy on Small Ensembles of Molecules in Solution. J Phys Chem Lett 10, 1967-1972 (2019).
36. G. S. S. Saini, et al., Rhodamine 6G interaction with solvents studied by vibrational spectroscopy and density functional theory. J Mol Struct 931, 10-19 (2009).
37. H. Watanabe, N. Hayazawa, Y. Inouye, S. Kawata, DFT Vibrational Calculations of Rhodamine 6G Adsorbed on Silver: Analysis of Tip-Enhanced Raman Spectroscopy. J Phys Chem B 109, 5012-5020 (2005).
38. M. Kasha, Characterization of electronic transitions in complex molecules. Discuss Faraday Soc 9, 14-19 (1950).
39. K. Tarafder, Y. Surendranath, J. H. Olshansky, A. P. Alivisatos, L.-W. Wang, Hole Transfer Dynamics from a CdSe/CdS Quantum Rod to a Tethered Ferrocene Derivative. J Am Chem Soc 136, 5121-5131 (2014).
40. O. M. Pearce, J. S. Duncan, N. H. Damrauer, G. Dukovic, Ultrafast Hole Transfer from CdS Quantum Dots to a Water Oxidation Catalyst. The Journal of Physical Chemistry C 122, 17559-17565 (2018).
41. M. Y. Ivanov, M. Spanner, O. Smirnova, Anatomy of strong field ionization. J Mod Opt 52, 165-184 (2005).
42. S. v Popruzhenko, Keldysh theory of strong field ionization: history, applications, difficulties and perspectives. Journal of Physics B: Atomic, Molecular and Optical Physics 47, 204001 (2014).
43. T. Maeda, T. Nagahara, M. Aida, T. Ishibashi, Identification of chemical species of fluorescein isothiocyanate isomer-I (FITC) monolayers on platinum by doubly resonant sum-frequency generation spectroscopy. Journal of Raman Spectroscopy 39, 1694-1702 (2008).
44. J. Yenagi, A. R. Nandurkar, J. Tonannavar, 2-Methoxyphenyl isocyanate and 2-Methoxyphenyl isothiocyanate: Conformers, vibration structure and multiplet Fermi resonance. Spectrochim Acta A Mol Biomol Spectrosc 91, 261-268 (2012).
45. J. Y. Park, et al., Effect of isotope substitution on the Fermi resonance and vibrational lifetime of unnatural amino acids modified with IR probe: A 2D-IR and pump-probe study of 4-azido-L-phenyl alanine. J Chem Phys 153, 164309 (2020).
46. J. Zhang, et al., Identifying and Modulating Accidental Fermi Resonance: 2D IR and DFT Study of 4-Azido-1-phenylalanine. J Phys Chem B 122, 8122-8133 (2018).
47. W. Liu, et al., Compact Biocompatible Quantum Dots Functionalized for Cellular Imaging. J Am Chem Soc 130, 1274-1284 (2008).
48. J. K. Jaiswal, E. R. Goldman, H. Mattoussi, S. M. Simon, Use of quantum dots for live cell imaging. Nat Methods 1, 73-78 (2004).
49. M. Bruchez, M. Moronne, P. Gin, S. Weiss, A. P. Alivisatos, Semiconductor Nanocrystals as Fluorescent Biological Labels. Science (1979) 281, 2013-2016 (1998).
50. F.-K. Lu, et al., Label-free DNA imaging in vivo with stimulated Raman scattering microscopy. Proceedings of the National Academy of Sciences 112, 11624-11629 (2015).
51. S. M. Fica-Contreras, et al., Long Vibrational Lifetime R-Selenocyanate Probes for Ultrafast Infrared Spectroscopy: Properties and Synthesis. J Phys Chem B 125, 8907-8918 (2021).
52. W. R. Zipfel, et al., Live tissue intrinsic emission microscopy using multiphoton-excited native fluorescence and second harmonic generation. Proceedings of the National Academy of Sciences 100, 7075-7080 (2003).
53. I. Georgakoudi, et al., NAD (P) H and Collagen as in Vivo Quantitative Fluorescent Biomarkers of Epithelial Precancerous Changes1. Cancer Res 62, 682-687 (2002).
54. D. Zhong, S. K. Pal, D. Zhang, S. I. Chan, A. H. Zewail, Femtosecond dynamics of rubredoxin: Tryptophan solvation and resonance energy transfer in the protein. Proceedings of the National Academy of Sciences 99, 13-18 (2002).

1. A multiplexed widefield imaging method comprising:
spatially focusing femtosecond infrared (IR) pulses and visible pulses delayed by a controlled temporal delay onto a sample comprising at least one chromophore to excite spontaneous emitted photoluminescence (PL) signals from the at least one chromophore; and
detecting at a detector the PL signals to generate PL images, wherein intensities of the PL signals within the PL images are a function of optical frequencies of the IR and visible pulses and the temporal delay.

2. The method of claim 1, further comprising chopping the IR pulse using an optical chopper;
synchronizing a frame rate of the detector with the optical chopper; and
determining an intensity difference of PL signals acquired with and without the IR pulse, wherein the intensity difference indicates a subset of PL signals that are encoded by the IR pulse.

3. The method of claim 2, wherein the subset of PL signals that are encoded by the IR pulse are generated by molecular excitation.

4. The method of claim 3, wherein the molecular excitation comprises double resonance, wherein the IR pulse promotes molecules within the one or more chromophore to an exited vibrational state and the visible pulse promotes the molecules to an electronic excited level.

5. The method of claim 2, wherein the at least one chromophore comprises quantum dots (QDs) and the subset of PL signals that are encoded by the IR pulse comprise strong field ionization of excitons of QDs.

6. The method of claim 1, wherein detecting further comprises collecting the PL signals using a refractive objective to form a widefield image at the detector.

7. The method of claim 1, where the detector is an array of pixels configured acquire to a widefield image in a single frame.

8. The method of claim 1, wherein the femtosecond pulses are generated using a femtosecond laser having a repetition rate in the range from 1 to 1,000 kHz, wherein the femtosecond laser is used to pump one or more optical parametric amplifiers (OPA) to produce the IR and visible pulses.

9. The method of claim 1, wherein the sample comprises cells co-stained with chromophores comprising quantum dots (QDs) and molecular dye having at least partially overlapping PL spectra, wherein the QDs and molecular dyes are distinguishable by tuning the temporal delay.

10. The method of claim 1, wherein the at least one chromophore comprises multiple chromophores having at least partially overlapping PL spectra, wherein the multiple chromophores are distinguishable via different responses to a mid-infrared pulse.

11. The method of claim 10, wherein the different responses comprise intramolecular anharmonic coupling between different vibrational modes or Fermi resonances.

12. A method for distinguishing chromophores in a sample comprising:
spatially focusing femtosecond IR and visible pulses delayed by a controlled temporal delay onto the sample stained with chromophores to excite spontaneous emitted PL signals;
detecting at a detector the PL signals to generate a PL image, wherein intensities within the PL image are a function of optical frequencies of the IR and visible pulses and the temporal delay.

13. The method of claim 12, further comprising chopping the IR pulse using an optical chopper;
synchronizing a frame rate of the detector with the optical chopper; and
determining an intensity difference of PL signals acquired with and without the IR pulse, wherein the intensity difference indicates a subset of PL signals that are encoded by the IR pulse.

14. The method of claim 13, wherein the subset of PL signals that are encoded by the IR pulse are generated by molecular excitation.

15. The method of claim 14, wherein the molecular excitation comprises double resonance, wherein the IR pulse promotes molecules within the chromophores to an exited vibrational state and the visible pulse promotes the molecules to an electronic excited level

16. The method of claim 12, wherein the chromophores comprise quantum dots (QDs) and the subset of PL signals that are encoded by the IR pulse comprise strong field ionization of excitons of QDs.

17. The method of claim 12, wherein detecting further comprises collecting the PL signals using a refractive objective to form a widefield image at the detector.

18. The method of claim 12, where the detector is an array of pixels configured acquire to a widefield image in a single frame.

19. The method of claim 12, wherein the femtosecond pulses are generated using a femtosecond laser having a repetition rate in the range from 1 to 1,000 kHz, wherein the femtosecond laser is used to pump one or more optical parametric amplifiers (OPA) to produce the IR and visible pulses.

20. The method of claim 12, wherein the sample comprises cells co-stained with chromophores comprising quantum dots (QDs) and molecular dye having at least partially overlapping PL spectra, wherein the QDs and molecular dyes are distinguishable by tuning the temporal delay.

21. The method of claim 12, wherein the chromophores have at least partially overlapping PL spectra, wherein the chromophores are distinguishable via different responses to a mid-infrared pulse.

22. The method of claim 21, wherein the different responses comprise intramolecular anharmonic coupling between different vibrational modes or Fermi resonances.
